(19) United States
(12) Patent Application Publication
(10) Pub. No.: US 2012/0281288 A1
(43) Pub. Date: Nov. 8, 2012

(54) CONTROL DEVICE

(75) Inventors: Stephen CHAPMAN, Pinner (GB); Luke WOOLFSON, London (GB); Christopher HALL, London (GB)

(73) Assignee: FILMLIGHT LIMITED, London (GB)

(21) Appl. No.: 13/289,378

(22) Filed: Nov. 4, 2011

(30) Foreign Application Priority Data
Nov. 8, 2010 (GB) 1018814.2

(51) Int. Cl. G02B 5/02

(52) U.S. Cl. 359/599

(57) ABSTRACT

A control device is described that has a controller, an optical diffuser and a lens assembly. In use, the optical diffuser is positioned in front of an electronic display and the lens assembly projects an image displayed on the electronic display onto the optical diffuser. Also, a keyboard and/or control panel having one and/or more of the control devices is presented.

### CROSS-REFERENCE TO RELATED APPLICATIONS

This application claims the benefit of UK Patent Application No. GB 1018814.2, titled “A Control Device,” filed Nov. 8, 2010, the contents of which are hereby incorporated by reference in its entirety.

### FIELD OF THE INVENTION

The present invention relates to a control device for displaying an image. More particularly, the present invention relates to a customizable control device.

### BACKGROUND OF THE INVENTION

It is known from US Patent Application Publication No. 2004/0074751 to provide an illuminated switch comprising a pushbutton unit and a lamp house in which a light emitting diode (LED) is mounted. The LED illuminates a diffuser sheet on which indicia, such as “ON”, are printed to indicate the function of the switch. A similar arrangement is known from GB Patent No. 233478.

U.S. Pat. No. 5,703,625 discloses an illuminated pushbutton display comprising an illuminated display and an integral keypad. The keypad is formed from an optically translucent and/or transparent material. This enables the graphics generated by the display to be viewed through a central lens. Light from the display also provides a backlight for the separate buttons.

PCT Patent Application Publication No. WO 2007/134359 discloses providing a tactile key switch which is mounted on a programmable display. A block of parallel optical fibres forms an image conduit which is mounted in contact with the screen. The image conduit is fixed in position and does not move when the key is pressed. As a result, the image is fixed below the surface of the key switch and is only visible from relatively steep viewing angles. This is a particular limitation if the key switch is to be employed in a control panel having a large control surface since part and/or all of the displayed image may be obscured at shallow viewing angles.

It is also known to provide Organic Light Emitting Diode (OLED) displays in pushbuttons. However, these devices can prove difficult to control and offer less flexible than standard graphics technology. Furthermore, OLED displays are relatively expensive and this can limit their suitability for certain applications.

The present invention sets out to overcome and/or ameliorate limitations of the devices disclosed in the related art.

### SUMMARY

The following presents a simplified summary in order to provide a basic understanding of some aspects of the claimed subject matter. This summary is not an extensive overview, and is not intended to identify key/critical elements and/or to delineate the scope of the claimed subject matter. Its purpose is to present some concepts in a simplified form as a prelude to the more detailed description that is presented later.

Viewed from a first aspect, a control device is provided, comprising: a controller; an optical diffuser for operative positioning in front of an electronic display; and a lens assembly for projecting an image displayed on the electronic display onto the optical diffuser.

Other aspects include features where the lens assembly is arranged such that an image displayed on the optical diffuser is smaller than a corresponding source image displayed on the electronic display; and/or wherein the lens assembly comprises at least one lens, the at least one lens being fixedly and/or movably mounted; and/or wherein the diffuser is fixedly and/or movably mounted; and/or wherein the controller comprises an operating member movable from a first position to a second position; and/or wherein the diffuser is mounted on said operating member; and/or wherein said movable operating member is a pushbutton; and/or wherein the lens assembly is configured to focus the projected image onto the diffuser when the pushbutton is in said first position.

Yet other aspects include features wherein a resilient member biases the pushbutton towards said first position; and/or wherein said movable operating member is a rotary knob and/or a slider member; and/or wherein said controller comprises one and/or more of the following: a sensor, a transducer, a switch, an encoder and/or a potentiometer; and/or wherein the optical diffuser is associated with the controller; and/or wherein the lens assembly comprises two aspheric meniscus lenses and a Fresno lens; and/or wherein the above features are used in combination with an electronic display screen; and/or wherein a keyboard and/or control panel comprising one and/or more control devices as described herein is utilized.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings. As such, other aspects of the disclosure are found throughout the specification.

### BRIEF DESCRIPTION OF THE DRAWINGS

Embodiment(s) of an exemplary control device will now be described, by way of example only, with reference to the accompanying figures, in which:

FIG. 1 shows a side elevation of an exemplary control device;

FIG. 2 shows a plan view from above of the exemplary control device;

FIG. 3 shows a plan view from below of the exemplary control device;

FIG. 4 shows a transverse cross-section of the exemplary control device along section lines B-B of FIG. 2; and

FIG. 5 is a cross-sectional isometric view of the exemplary control device along the section lines B-B of FIG. 2.

### DETAILED DESCRIPTION

Various methods and systems for a control device is described, wherein in one exemplary embodiment, a controller is provided, comprising an optical diffuser for operative positioning in front of an electronic display; and a lens assembly for projecting an image displayed on the electronic display onto the optical diffuser.

The image projected onto the diffuser can be customized by altering the image displayed on the electronic display screen. The image projected onto the diffuser can be viewed by a user and typically provides an indication of the functionality of the controller. The function of the controller can be changed dynamically, for example dependent on a particular context and/or operational mode. The image displayed on the electronic display can be changed to indicate a change in the function of the controller. The control device can be programmable and/or implemented as part of a programmable interface.

By utilizing a lens assembly to project a displayed image onto the diffuser, standard graphics technologies can be employed to generate the source image on the electronic display. Thus, at least in preferred embodiments, the control device can provide a high degree of flexibility whilst being easily controlled. Furthermore, the image displayed on the control device can have a high resolution. Thus, additional detail/information can be displayed on the control device. Moreover, anti-aliased graphics can be displayed.

At least in exemplary embodiments, the image displayed on the diffuser can be viewed over a wide viewing angle. This allows the control device to be employed in a wide range of applications. Since the indicia can be viewed from a shallow viewing angle, the control device offers good scalability and can be used in a range of applications. For example, the control device can be used on a desk control panel, such as an audio and/or video controller desk.

It will be appreciated that the image displayed on the diffuser may comprise alphanumeric characters, words, symbols, pictures, graphics and/or any combination thereof. A single key and/or matrix of keys can display a moving image and/or a static image. A matrix of keys can also be employed to show a large image mapped across all the keys.

The lens assembly is typically provided between the electronic display and the optical diffuser.

The lens assembly can project an image onto the optical diffuser which is the same size as the image displayed on the electronic display screen (i.e., magnification=1). The lens assembly can be adapted to magnify the image displayed on the electronic display so that the displayed image is larger (i.e., magnification >1). Alternatively, the lens assembly can be adapted such that the image displayed on the optical diffuser is smaller than the corresponding source image displayed on the electronic display (i.e. magnification <1). This can allow a more efficient exploitation of the display area and/or higher brightness. Furthermore, this arrangement enables an image having a higher resolution to be displayed on the diffuser.

The controller can be movably mounted on a fixed housing. The housing can, for example, be adapted to mount the control device.

The lens assembly can comprise one and/or more lenses which are fixedly and/or movably mounted. The lens assembly can be fixedly and/or movably mounted. The lens assembly can be mounted in the housing and/or on the controller. The housing can be operatively mounted proximal to and/or in contact with the electronic display screen.

The diffuser can be fixedly mounted. Alternatively, the diffuser can be movably mounted, for example axially and/or rotatably mounted. The diffuser can be mounted adjacent to and/or on the controller. An at least partially transparent screen can be provided over the diffuser.

The controller can comprise an operating member movable from a first position to a second position to operate the control device. The diffuser can be mounted in said operating member.

The movable operating member can be a pushbutton. The pushbutton can be extended (i.e. un-pressed) in said first position; and can be depressed in said second position. The diffuser can be mounted in the pushbutton. The diffuser can be located at and/or proximal to an actuating surface of the pushbutton (i.e. the surface engaged by a user to actuate the pushbutton). The lens assembly can be configured to focus the projected image onto the diffuser when the pushbutton is in its first position. A resilient member can be provided to bias the pushbutton towards said first position and/or said second position.

The movable operating member can be a rotary knob. The diffuser can be fixedly and/or movably mounted in the rotary knob.

The movable operating member can be a slider member. The diffuser can be fixedly and/or movably mounted in the slider member.

The lens assembly can comprise first, second and third lenses. Of course, less than and/or more than three lenses could be employed.

The first and second lenses can be mounted on a movable portion of the controller. For example, the first and second lenses could be mounted on the pushbutton and/or the rotary knob. Alternatively, the first and second lenses can be mounted in a fixed housing. The first and second lenses can be a pair of aspheric meniscus lenses. The meniscus lenses have convex lenses which can be arranged to face outwardly in opposite directions.

The third lens can be fixedly mounted in a housing. Alternatively, the third lens can be mounted on the operating member of the controller. For example, the third lens could be mounted on the pushbutton and/or the rotary knob. The third lens can be a Fresno lens.

The lens assembly could be mounted on a chassis which is movable with the operating member. In use, the spacing between the lenses would remain substantially fixed, but the lenses could be moved relative to the electronic display with the chassis as a unit. For example, the chassis could be coupled to and/or formed integrally with the operating member of the controller. The optical diffuser could also be mounted on the chassis.

The exemplary embodiment(s) can also relate to a control device of the type described herein in combination with an electronic display screen.

Moreover, the exemplary embodiment(s) can also relate to a keyboard and/or control panel comprising one and/or more control devices as described herein.

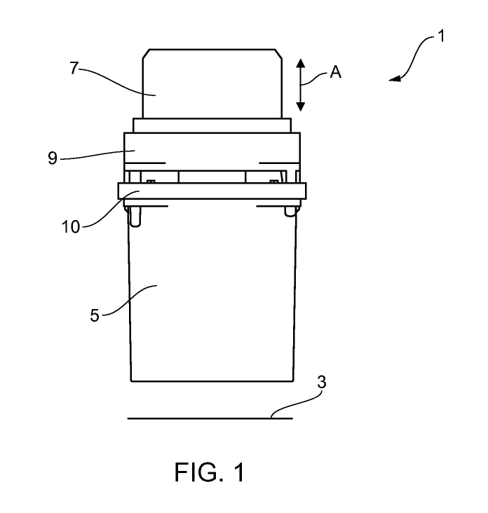

Referring now to the Figures, FIGS. 1-5 are illustrations of exemplary embodiments of a customizable control device 1 for mounting on an electronic display screen 3. The control device 1 comprises a lens housing 5, a pushbutton 7 and a pushbutton guide 9. The control device 1 provides a pushbutton type key suitable for use in a control panel and/or a keyboard.

The control device 1 is mounted on a printed circuit board (PCB) 10 located between the lens housing 5 and the pushbutton guide 9. The electrical contacts (C) for the control device 1 are provided on the PCB 10. The electrical contacts are completed/broken in a conventional manner when the pushbutton 7 is actuated.

The display screen 3 is illustrated as being spaced apart from the bottom of the lens housing 5. In practice, only a small gap is maintained between the display screen 3 and the housing 5.

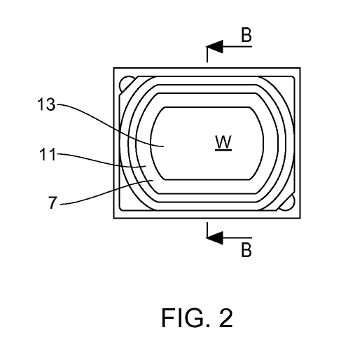

As illustrated by the arrow A in FIG. 1, the pushbutton 7 is movable in an axial direction. As shown in FIG. 2, the pushbutton 7 has a generally racetrack shape in plan form. The pushbutton 7 comprises an inner cap 11, an outer cap 13 and an optical diffuser 15. The inner cap 11 is at least partially transparent and/or translucent. The outer cap 13 is opaque and is fixedly mounted over the inner cap 11. An aperture in the top of the outer cap 13 forms a window (W) through which the diffuser 15 is visible. The inner cap 11 provides a protective screen over the diffuser 15. The window (W) is smaller in plan form than the diffuser 15 to eliminate a line of sight to the lenses 26, 27, 28. In the present embodiment, the diffuser 15 and the outer cap 13 are both black to create a seamless black key.

The diffuser 15 is a bead based diffuser which can give a wide even viewing angle suitable for a large control surface and to provide a good contrast ratio in ambient light. A suitable diffuser 15 is the Vikuiti Rear Projection Film produced by 3M and described in U.S. Pat. No. 6,519,087. The diffuser 15 is bonded to the inner cap 11 in the present embodiment, but this is not essential.

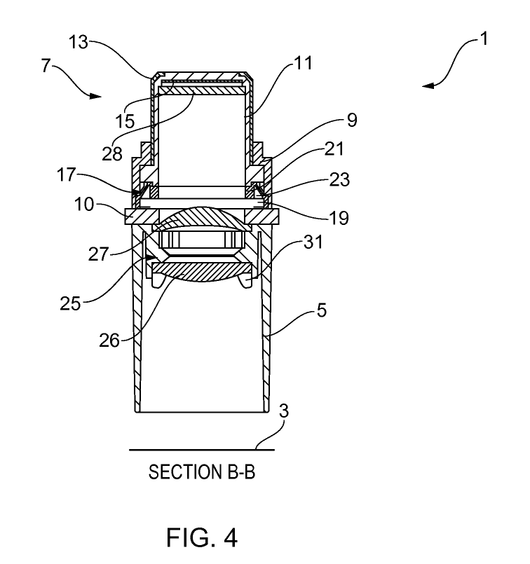

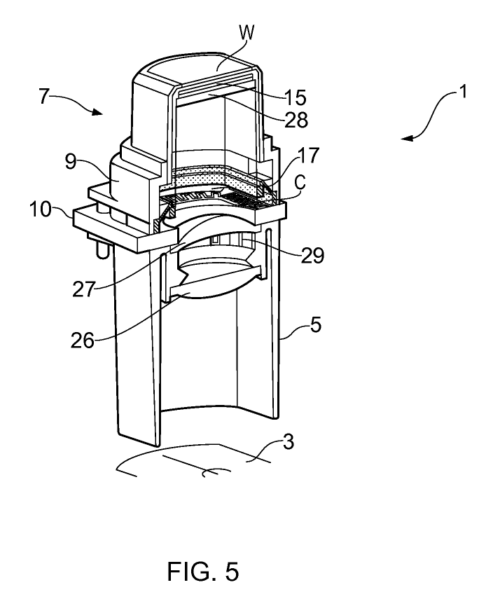

The pushbutton 7 is movable axially within the guide 9 from a first extended position to a second depressed position. As shown in FIGS. 4 and 5, a resilient key pad 17 is provided inside the pushbutton guide 9 to bias the pushbutton 7 towards its first extended position. The key pad 17 is made of a resilient material and comprises a first frame member 19, a second frame member 21 and an intermediate resilient skirt 23. The first frame member 19 mounts the key pad 17 fixedly on the housing 5 and the second frame member 21 engages the bottom of the pushbutton 7. The resilient skirt 23 extends between the first and second frame members 21, 23 and serves as a spring member.

A lens assembly 25 is provided in the housing 5 and the pushbutton 7 to project an image from the display screen 3 onto the optical diffuser 15. The lens assembly 25 comprises a first lens 26 and a second lens 27 mounted in the housing 5; and a third lens 28 mounted in the pushbutton 7 under the optical diffuser 15. The first and second lenses 26, 27 are both aspheric meniscus lenses; and the third lens 28 is a Fresnel field lens. An aperture 29 is formed in the housing 5 between the first and second lenses 26, 27 and this also forms part of the lens assembly 25.

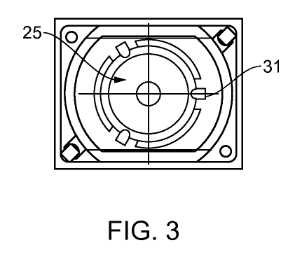

The first and second lenses 26, 27 are provided at the end of the housing 5 distal from the electronic display screen 3 and the sidewalls of the housing 5 serve as an optical shroud/shield to reduce and/or stop light entering the lens system from a neighboring key. As shown in FIGS. 3 and 4, the first lens 27 is secured in the lens housing 5 by three resilient arms 31; and the second lens 28 is fixedly mounted in a recess formed between the lens housing 5 and the PCB 10.

The lens assembly 25 provides an optics system made nearly telecentric on the image side with the third lens 28. This telecentricity can significantly reduce vignetting of the image, as viewed on the optical diffuser 15. The first and second aspheric meniscus lenses 26, 27 are mounted either side of a stop with their convex surfaces facing outwards. This arrangement can help to reduce off-axis aberrations. The curves and locations about the stop are optimized for image quality and the two aspheric surfaces balance out inherent spherical aberration to further improve clarity.

The lenses 26, 27, 28 are arranged such that, in use, the image projected onto the optical diffuser 15 is smaller than the corresponding source image displayed on the electronic display screen 3. This arrangement is desirable since the image displayed on the optical diffuser 15 has a higher resolution. In certain embodiments, it may be desirable to magnify the image projected onto the optical diffuser 15 and the lens assembly 25 can be adapted accordingly.

A programmable control unit (not shown), such as a workstation and/or a personal computer, can be provided to control the image displayed on the electronic display screen 3 and the associated functionality of the control device 1. The image displayed on the electronic display screen 3 for projection onto the diffuser 15 can comprise one and/or more indicium, for example including alphanumeric characters, symbols, images and/or other graphics. The image displayed on the electronic display screen 3 may be a bitmap image.

The operation of the control device 1 will now be described with reference to the Figures. An image is displayed on the display screen 3 under the control of the control unit. The lens assembly 25 projects the display image onto the diffuser 15 and the resultant projected image is visible to a user through the transparent inner lens cap 11. The projected image is inverted and this is accommodated by displaying the image with the appropriate orientation on the display screen 3.

The lens assembly 25 is arranged such that the image projected onto the optical diffuser 15 is in focus when the pushbutton 7 is in its first extended position. Thus, the displayed image is clearly visible to a user even at shallow viewing angles. When the pushbutton 7 is pressed the diffuser 15 moves towards the lens assembly 25 causing the displayed image to go out of focus. However, since the diffuser 15 is usually at least partially obscured by the user's finger, it is less important that the projected image remains in focus.

In its second position, the pushbutton 7 completes an electrical circuit on the PCB 10 thereby enabling the actuation of the pushbutton 7 to be detected. This aspect of the operation of the pushbutton 7 is conventional.

The movement of the pushbutton 7 from said first position to said second position causes the resilient skirt 23 to deform. Upon release, the stored elastic energy in the resilient skirt 23 biases the pushbutton 7 back to its first extended position.

The function and/or operation performed upon actuation of the pushbutton 7 is determined by the programmable control unit. By displaying a different source image on the underlying electronic display screen 3, the image projected onto the diffuser 15 can be altered. The control unit changes the projected image to provide the user with a visual indication of the functionality of the pushbutton 7.

The pushbutton 7 can be customized, for example to provide different functions depending on an operational mode of a device in which the control device 1 is installed (i.e. the pushbutton 7 can be context sensitive). Moreover, the image projected onto the diffuser 15 can change in real time. The projected image could, for example, be animated. Alternatively, by displaying a black square on the electronic display screen 3, no image will be projected onto the diffuser 15 and this could serve to indicate that the pushbutton 7 is not in use.

The exemplary control device 1 can form part of a dynamic control interface. The control interface could comprise a plurality of said control devices 1.

It will be appreciated that a plurality of control devices can overlay a single electronic display screen 3. In this arrangement, a plurality of images are displayed on the electronic display screen, each image corresponding to a particular control device 1. The control unit can control the function of each control device 1 and the associated display image(s) independently.

It will be appreciated that various changes and modifications can be made to the exemplary control device 1. For example, the combination of a lens assembly 25 and diffuser 15 could be employed in other types of controller, for example encoders, transducers, switches and the like. The combination of a lens assembly 25 and diffuser 15 could also be employed to display an image on a static part of the control surface, for example instead of having another display screen for providing additional information (such as the value and/or function of an encoder).

Moreover, it will be appreciated that the control device 1 according to the description can be employed in a variety of different devices.

What is claimed is:

1. A control device comprising:
a controller;
an optical diffuser for operative positioning in front of an electronic display; and
a lens assembly for projecting an image displayed on the electronic display onto the optical diffuser.

2. The control device as claimed in claim 1, wherein the lens assembly is arranged such that an image displayed on the optical diffuser is smaller than a corresponding source image displayed on the electronic display.

3. The control device as claimed in claim 1, wherein the lens assembly comprises at least one lens, the at least one lens being fixedly and/or movably mounted.

4. The control device as claimed in claim 1, wherein the diffuser is fixedly and/or movably mounted.

5. The control device as claimed in claim 1, wherein the controller comprises an operating member movable from a first position to a second position.

6. The control device as claimed in claim 5, wherein said diffuser is mounted on said operating member.

7. The control device as claimed in claim 5, wherein said movable operating member is a pushbutton.

8. The control device as claimed in claim 7, wherein the lens assembly is configured to focus the projected image onto the diffuser when the pushbutton is in said first position.

9. The control device as claimed in claim 8, further comprising a resilient member to bias the pushbutton towards said first position.

10. The control device as claimed in claim 5, wherein said movable operating member is a rotary knob and/or a slider member.

11. The control device as claimed in claim 1, wherein said controller comprises one and/or more of a sensor, a transducer, a switch, an encoder and/or a potentiometer.

12. The control device as claimed in claim 1, wherein the optical diffuser is associated with the controller.

13. The control device as claimed in claim 1, wherein the lens assembly comprises two aspheric meniscus lenses and a Fresno lens.

14. The control device as claimed in claim 1, in combination with an electronic display screen.

15. A control panel with a plurality of control devices, each of the control devices comprising:
a controller;
an optical diffuser for operative positioning in front of an electronic display; and
a lens assembly for projecting an image displayed on the electronic display onto the optical diffuser.

16. A keyboard with a plurality of control devices, each of the control devices comprising:
a controller;
an optical diffuser for operative positioning in front of an electronic display; and
a lens assembly for projecting an image displayed on the electronic display onto the optical diffuser.
